(19) United States
(12) Patent Application Publication
(10) Pub. No.: US 2022/0198291 A1
(43) Pub. Date: Jun. 23, 2022

(54) SYSTEMS AND METHODS FOR EVENT DETECTION

(71) Applicant: OneEvent Technologies, Inc., Mount Horeb, WI (US)

(72) Inventors: Ronald N. Gnau, Monona, WI (US); Kurt Joseph Wedig, Mount Horeb, WI (US); Daniel Ralph Parent, Mount Horeb, WI (US)

(21) Appl. No.: 17/112,572

(22) Filed: Dec. 21, 2020

(51) Int. Cl. G06N 5/04; G06N 5/00; G06N 20/20

(52) U.S. Cl. CPC G06N 5/04; G06N 20/20; G06N 5/003

(57) ABSTRACT

An event detection system includes a remote computing device comprising a processor configured to communicably couple to one or more sensors. The event detection system is configured to access a first model, a second model, and a third model, receive current data from the one or more of the sensors, determine that an event or possible emergency condition is present based on the first model, second model, third model, and current data, and cause a notification to be transmitted in response to determining the presence of the event or possible emergency condition.

### FIELD OF THE DISCLOSURE

The present disclosure relates generally to a system for event detection. More particularly, the present disclosure relates to systems and methods for detecting an event based on sensor data.

### BACKGROUND

The present disclosure relates generally to event detection systems. Event detection systems can be used to monitor one or more conditions. For example, a variety of sensors may be used to monitor one or more conditions within a respective area. One such sensor may include a thermal sensor that is configured to monitor the temperature within a room. Event detection systems may monitor the conditions to trigger an alarm that is indicative of an event. However, the conditions that should trigger an alarm may vary depending upon the implementation.

### SUMMARY

One implementation of the present disclosure is related to a method of event detection, according to some embodiments. The method includes accessing, by an event detection system, a first model, a second model, and a third model, receiving, by the event detection system, current data from one or more of the sensors, wherein the current data comprises a real-time value from one or more of the sensors, determining, by the event detection system, that an event is present based on the current data, the first model, the second model, and the third model, and causing, by the event detection system, a notification to be transmitted in response to determining the event. In some embodiments, the set of model values represent historical timestamped values corresponding to each of the one or more sensors.

In some embodiments, determining that the event is present includes inputting the current data into the first model to make a first determination whether the event is present, inputting the current data into the second model to make a second determination whether event is present, inputting the current data into the third model to make a third determination whether the event is present, and determining that the event is present based on the first determination, the second determination, and the third determination. In some embodiments, the current data further comprises an arithmetic mean of the values received from the one or more sensors over the previous three minutes, an arithmetic mean of the values received from the one or more sensors over the previous thirty minutes, and an arithmetic mean of the values received from the one or more sensors over the previous three hours. In some embodiments, causing the notification to be transmitted causes an alarm to sound and notify occupants in an area associated with the event.

Another implementation is directed to an event detection system. The event detection system includes a sensor configured to sense data that can indicate an event in a structure, and a processing circuitry in communication with the sensor. The processing circuitry includes a transceiver configured to receive the data from the sensor over time, a memory configured to store the data, wherein the data comprises a plurality of values that are each indicative of a sensed condition at a unique time, and a processor operatively coupled to the memory and the transceiver. The processor is configured to determine a set of model values using the data received from the sensor over a period of time, generate a first model corresponding to a first machine learning model, a second model corresponding to a second machine learning algorithm, and a third model corresponding to a third algorithm, determine that an event is present based on current data received from the sensor, the first model, and the third model, where the recent data comprises a real-time value of the sensor, and transmit a notification in response to determining the event is present. In some embodiments, the current data further comprises an arithmetic mean of the values received from sensor over the previous three minutes, an arithmetic mean of the values received from the sensor the previous thirty minutes, and an arithmetic mean of the values received from the sensor over the previous three hours.

In some embodiments, determining that the event is present includes inputting the current data into the first model to make a first determination whether the event is present, inputting the current data into the second model to make a second determination whether event is present, inputting the current data into the third model to make a third determination whether the event is present, and determining that the event is present based on the first determination, the second determination, and the third determination. In some embodiments, the third determination indicates that the event is present when the real-time value of the current data exceeds an upper set point. In some embodiments, to determine that the event is present based on the first determination, the second determination, and the third determination, the processor is further configured to implement an ensemble, wherein the ensemble comprises a majority vote of the first determination, the second determination, and the third determination.

Another implementation is directed to a method of event detection. The method includes accessing, by the event detection system, historical data, the historical data comprising timestamped values detected by one or more sensors over a first time period, determining, by the event detection system, a set of model values using the time stamped values, generating, by the event detection system, a first model from the set of values and a second model from the set of model values, receiving, by the remote computing device, current data from one or more of the sensors, wherein the current data comprises a real-time value from one or more of the sensors, determining, by the remote computing device, that an event is present based on the current data, the first model, and the second model, and causing, by the remote computing device, a notification to be transmitted in response to determining the event is present.

These and other aspects and implementations are discussed in detail below. The foregoing information and the following detailed description include illustrative examples of various aspects and implementations, and provide an overview or framework for understanding the nature and character of the claimed aspects and implementations. The drawings provide illustration and a further understanding of the various aspects and implementations, and are incorporated in and constitute a part of this specification.

### BRIEF DESCRIPTION OF THE DRAWINGS

The accompanying drawings are not intended to be drawn to scale. Like reference numbers and designations in the various drawings indicate like elements. For purposes of clarity, not every component can be labeled in every drawing. In the drawings:

FIG. 1 is a block diagram of an event detection system in accordance with an illustrative embodiment.

FIG. 2 is a flow diagram of a method of detecting an event in accordance with an illustrative embodiment.

FIG. 3 is a flow diagram of a method of generating a model based on historical data in accordance with an illustrative embodiment.

FIG. 4a is a flow diagram of a method of determining an occurrence of an event in accordance with an illustrative embodiment.

FIG. 4b is a block diagram depicting the flow of data in determining the presence of the event in accordance with an illustrative embodiment.

FIG. 5 is table including multiple variables and determined importance in event detection in accordance with an illustrative embodiment.

FIG. 6 is an example of a decision tree of random forest model in accordance with an illustrative embodiment.

### DETAILED DESCRIPTION

Referring generally to the FIGURES, systems and methods for event detection are shown, according to some embodiments. In some embodiments, the event detection system includes processing circuitry that is configured to communicate with one or more sensors. The one or more sensors may be positioned within various rooms or areas of a building or environment. The one or more sensors may each be configured to monitor a condition within respective rooms or areas. For example, a first sensor may be configured to monitor a temperature within a room, a second sensor may be configured to monitor a visual obscuration of the room, and third sensor may be configured to monitor for an amount of gas (e.g., carbon monoxide) within the room. Each sensor may monitor for respective conditions and output a value to the processing circuitry. In some embodiments, the values from the one or more sensors are stored within a memory either locally on the sensor or within a memory of the processing circuitry in order to create an electronic database of historical data. In some embodiments, the values from the one or more sensors are time stamped. In some embodiments, the historical data is used to generate and store a first model, a second model, and a third model. In some embodiments, the historical data is used to generate twelve or more models. In some embodiments, the first model, second model, and third model are each generated according to respective algorithms (e.g., machine learning algorithms, threshold models, etc.).

In some embodiments, the event detection system may access the first model, second model, and third model and use current data received from the one or more sensors to determine the presence of an event. For example, the processing circuitry may access the first model, second model, and third model from memory, input the current data into the first model to make a first determination, input the current data into the second model to make a second determination, and input the current data into the third model to make a third determination. Further, the processing circuitry may then determine that an event (e.g., a possible emergency condition such as a fire) is present based on the first, second, and third determinations. In some embodiments, the processing circuitry determines that the event is present based on whether a majority of the models (e.g., two out of the three) have indicated that the event is present (e.g., a majority vote). In some embodiments, the first, second, and third models output a binary indication (e.g., event is present or event is not present) of whether the event is present. In some embodiments, the first, second, and third models output a probability of whether the event is present. In this way, the event detection system is able to use multiple models that are based on historical data of sensors within a particular environment in order to determine the presence of an event, which increases the accuracy of the event detection and reduces false alarms. Further, the event detection system may continually update the models over time to increase accuracy. In addition, system and the methods described herein (e.g., utilizing an ensemble approach) allows for the system to overcome situational weaknesses of specific modeling methods in order to ensure events and non-events are accurately determined.

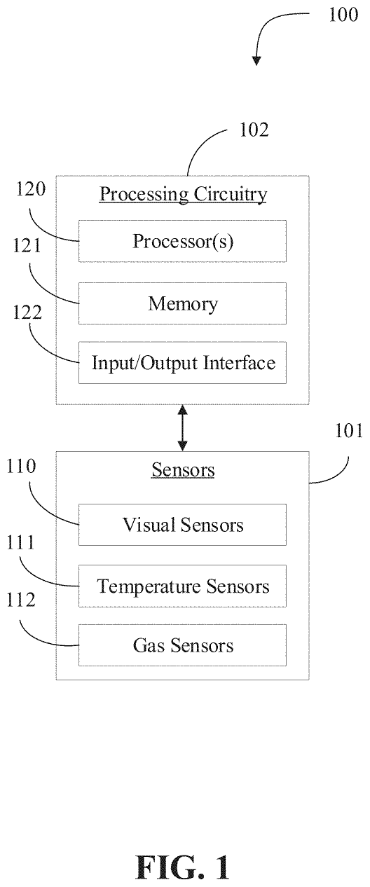

Referring now to FIG. 1, a block diagram of an event detection system 100 is shown. The event detection system 100 includes processing circuitry 102 configured to communicate with one or more sensors 101. In some embodiments, the one or more sensors 101 may be a part of an existing system already installed into an existing building or environment. In some embodiments, the one or more sensors 101 may be included in the event detection system 100.

In some embodiments, the sensors 101 may include visual sensors 110, temperature sensors 111, and/or gas sensors 112. In some embodiments, other various types of sensors may be implemented or used. The visual sensors 110 may be configured to monitor for an amount of obscuration within respective rooms or areas. The temperature sensors 111 may be configured to monitor a temperature within respective rooms or areas, and the gas sensors 112 may be configured to monitor an amount of gas (e.g., carbon monoxide) within respective rooms or areas. Each of the sensors 101 are configured to communicate with the processing circuitry 102.

The processing circuitry 102 may include a processor 120, a memory 121, and an input/output interface 122. In some embodiments the processing circuitry 102 may be integrated with various electronic devices. For example, in some embodiments, the processing circuitry 102 may be integrated with a personal computer, server system, or other computational device. In some embodiments, the processing circuitry 102 may also include one or more processors, microcontrollers, application specific integrated circuit (ASICs), or circuitry that are integrated with one or more of the sensors 101 and are designed to cause or assist with the sensors 101 in performing any of the steps, operations, processes, or methods described herein.

The processing circuitry 102 may include one or more circuits, processors 120, and/or hardware components. The processing circuitry 102 may implement any logic, functions or instructions to perform any of the operations described herein. The processing circuitry 102 can include memory 121 of any type and form that is configured to store executable instructions that are executable by any of the circuits, processors or hardware components. The executable instructions may be of any type including applications, programs, services, tasks, scripts, libraries, processes, and/or firmware. In some embodiments, the memory 121 may include a non-transitory computable readable medium that is coupled to the processor 120 and stores one or more executable instructions that are configured to cause, when executed by the processor 120, the processor 120 to perform or implement any of the steps, operations, processes, or methods described herein. In some embodiments, the memory 121 is configured to also store, with a database, information regarding the localized position of each of the sensors 101 and time-stamped output values of each of the sensors 101 over time. That is, the memory 121 may have a database that indicates a room that each of the sensors 101 is located and indicates the historical data including the time-stamped values detected by each of the sensors 101 at various times.

In some embodiments, input/output interface 122 of the processing circuitry 102 is configured to allow the processing circuitry 102 to communicate with the sensors 101 and other devices. In some embodiments, the input/output interface 122 may be configured to allow for a physical connection (e.g., wired or other physical electrical connection) between the processing circuitry 102 and the sensors 101. In some embodiments, the input/output interface 122 may include a wireless interface that is configured to allow wireless communication between the sensors 101 (e.g., a microcontroller on respective sensors connected to leads of the one or more coils) and the processing circuitry 102. The wireless communication may include a Bluetooth, wireless local area network (WLAN) connection, radio frequency identification (RFID) connection, or other types of wireless connections. In some embodiments, the input/output interface 122 also allows the processing circuitry 102 to connect to the internet (e.g., either via a wired or wireless connection). In some embodiments, the input/output interface 122 also allows the processing circuitry 102 to connect to other devices such as a display, alarm systems, personal devices, or other devices that may be configured to provide an alarm within an area or notification to a user.

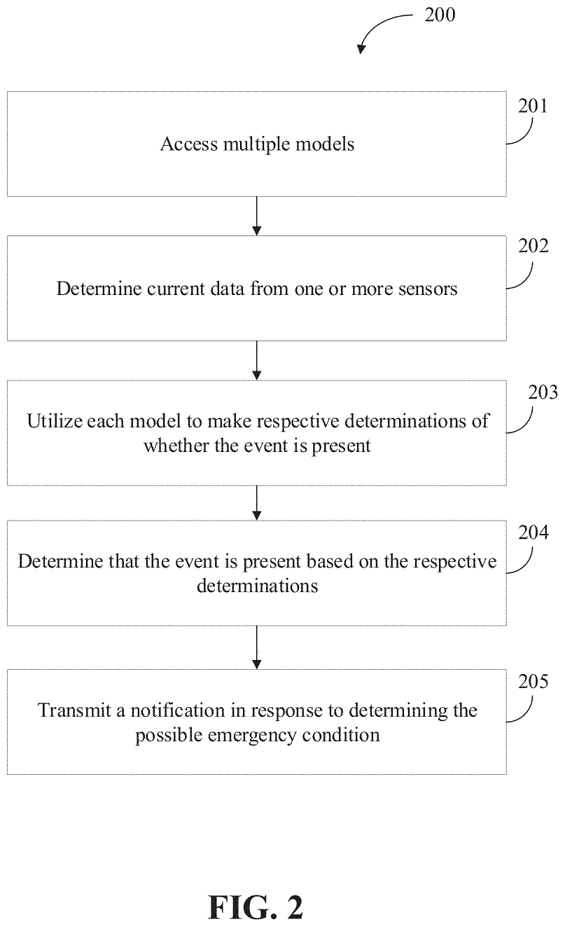

Referring now to FIG. 2, a flow diagram of a method 200 of detecting an event is depicted in accordance with an illustrative embodiment. In an operation 201, the event detection system accesses multiple models. In some embodiments, the multiple models include a first model, a second model, and a third model. In some embodiments, the multiple models may be stored within a memory. For example, the first model, the second model, and the third model may be stored within the memory and accessed for use by the processing circuitry 102. In some embodiments, each of the models accessed are based on historical data from the sensors 101 and a respective algorithm. For example, in some embodiments, the first model corresponds to a first machine learning algorithm that used the historical data from the sensors in order to generate or update the first model, the second model corresponds to a second machine learning algorithm that used the historical data from the sensors in order to generate or update the second model, and the third model corresponds to a third algorithm that used the historical data from the sensors in order to generate or update the third model. In some embodiments, more than three models are accessed. For example, in some embodiments, four, five, . . . , eleven, twelve, or more models may be accessed or received by the event detection system. As described further below, each of the models are configured to receive as an input current sensor data and output a respective determination. In some embodiments, the respective determinations are binary determinations (e.g., yes or no) for the presence of a particular event or alarm type within or relative to the structure being monitored. In some embodiments, the respective determinations indicate a probability or a value. In this way, each model classifies the conditions associated with the data determined by the sensors 101 as being an event (e.g., a potential or actual fire).

In an operation 202, current data from one or more sensors is determined. For example, the current data may include real-time values from the one or more sensors. The current data may also include real-time values from the one or more sensors over a period of time (e.g., over the last month, two months, three months, etc.). In some embodiments, the processing circuitry receives the current data and calculates an arithmetic mean of the values received from the one or more sensors over the previous three minutes, an arithmetic mean of the values received from the one or more sensors over the previous thirty minutes, and an arithmetic mean of the values received from the one or more sensors over the previous three hours. The current data is indicative of a sensed condition by each respective sensor.

In an operation 203, each model is utilized to make a respective determination whether an event present based on the current data. In some embodiments, the event is a possible emergency condition such as the presence of a fire, flood, or other emergency. For example, in some embodiments, the event detection system may input the current data into the first model to make a first determination of whether the event is present, input the current data into the second model to make a second determination of whether the event is present, and input the current data into the third model to make a third determination. In some embodiments, the first, second, and third determinations are binary determinations (e.g., yes an event is present or no the event is not present). In some embodiments, the first, second, and third determinations are probability values (e.g., 70% likely that the event is present).

In an operation 204, the event is determined to be present based on the respective determinations. That is, in some embodiments, the event detection system may ensemble the respective determinations output from each model in order to determine that the event is present. For example, in some embodiments, the event detection system may determine that the event is present based on the first, second, and third determinations.

In some embodiments, the event detection system may determine that the event is present via a majority vote of the respective determinations (e.g., the outputs of each model). For example, in an embodiment where the first, second, and third determinations are binary determinations (e.g., yes an event is present or no the event is not present), the event detection system may determine that the event is present if the majority of the respective determinations indicate that the event is present (e.g., yes). In another embodiment, where the first, second, and third determinations are probability values (e.g., 60% likely that the event is present). The event detection system may determine, for example, that the first determination is indicative that the event is present (e.g., yes) if the probability value of the first determination is greater than a first threshold. Further, the event detection system may determine that the second determination is indicative that the event is present (e.g., yes) if the probability value of the second determination is greater than a second threshold, and determine that the third determination is indicative that the event is present (e.g., yes) if the probability value of the second determination is greater than a third threshold. Moreover, the event detection system may then determine that the event is present based on whether a majority of the determinations (e.g., 2 out of 3) are indicative of the event being present. In some embodiments, the first, second, and third, thresholds may be stored or updated within a memory of the event detections system. In some embodiments, the first, second, and third, thresholds may be the same value (e.g., 70%). In some embodiments, the first, second, and third, thresholds may be different values depending upon the accuracy the respective models that correspond to the first, second, and third thresholds.

In some embodiments, the event detection system may determine that the event is present based on whether a weighted probability exceeds a threshold. For example, in an embodiment where the first, second, and third determinations are probability values (e.g., 70% likely that the event is present), the event detection system may determine a weighted probability (e.g., a weighted average) of the first, second, and third determinations. In some embodiments, a first weight may be multiplied by a first probability (e.g., corresponding to the first determination), a second weight may be multiplied by a second probability (e.g., corresponding to the second determination), and a third weight may be multiplied by a third probability (e.g., corresponding to the third determination), and the products may be averaged (e.g., added and divided by 3) in order to determine the weighted probability value. Accordingly, the event detection system may determine that the event is present if the weighted average exceeds a threshold. In some embodiments, the threshold may be stored and/or updated within a memory of the event detection system. In some embodiments, the threshold may be based on the particular models being utilized, the particular event that is being detected, or the level of risk that the event poses. Additionally, the weights (e.g., first, second, and third weights) may be stored within the memory. In some embodiments, the weights are determined based on the accuracy of each model. In some embodiments, the accuracy of each model may be determined when the models are generated or based on historical accuracy of the model.

In still further embodiments, a weighted majority vote count ensemble approach may be utilized in which binary determinations by certain models are weighted relative to other binary determinations. For example, a first model may be given a 3× weight, while second and third, less desirable models may only be given a 1× weight. Thus, a positive indication (e.g., yes) that the event is present would outweigh negative indications (e.g., no) by the second and third desirable models. In other embodiments an ensemble classification can be based on any combination of model classifications or probability estimates. Thus, weighting in an ensemble might be based on individual model performance, business rules, differences in how models work, or differences in how models perform in different situations. Weighting may adjust the emphasis of individual models to help improve and stabilize the overall classification performance of the ensemble. Weights could be mathematically or manually set to sum to 100% (or the whole) across all the elements used in the ensemble. In alternative embodiments any number of models and associated weights may be applied based on the circumstances of the structure being monitored, the models being used, environmental conditions, etc.

In operation 205, a notification is transmitted in response to determining the event is present. For example, the event detection system, in response to determining the event is present in operation 204, may generate and transmit a notification intended to notify a user or users that the event is or may be present. In some embodiments, the notification includes causing an alarm to sound in one or more of the rooms in which the sensors are positioned. In some embodiments, the notification includes a text message, automated phone call, push notification, or email sent to one or more devices of administrators, emergency authorities, or people associated with the area in which the event is present (e.g., employees that work in the area).

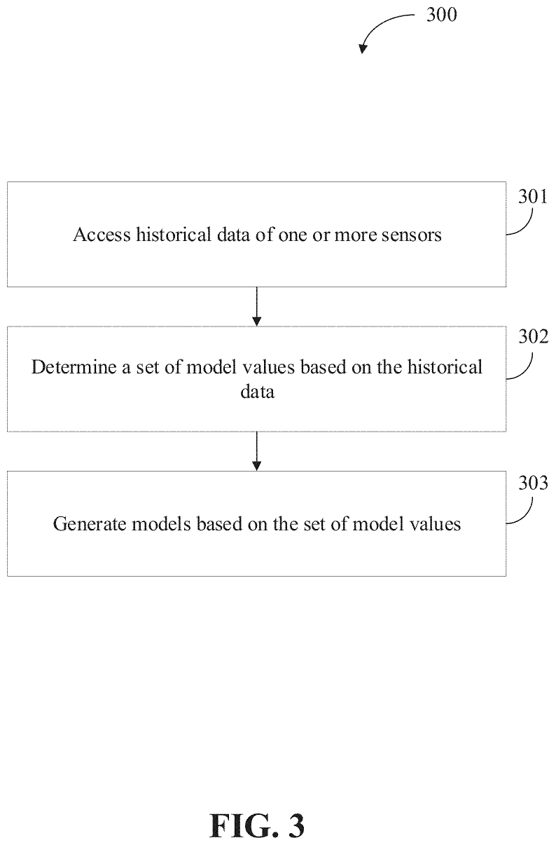

FIG. 3 is a flow diagram of a method of generating a model based on historical data in accordance with an illustrative embodiment. In an operation 301, historical data of one or more sensors is accessed. In some embodiments, the historical data of one or more sensors includes timestamped values from the one or more sensors over a first period of time (e.g., over a day, a month, two months, etc.). In some embodiments, the historical data may be referenced as training data for the models to be generated from. In some embodiments, the historical data is collected by the processing circuitry over time and stored within the memory. In some embodiments, the historical data may have been captured or stored before the event detection system was integrated with the one or more sensors. In some embodiments, the historical data may be accessed or received by the event detection system via querying a database or by querying the one or more sensors (e.g., if the one or more sensors include a local memory). The historical data allows for one or more models to be generated and/or updated in a supervised manner. That is, since the historical data is from a past time and it can be known whether an event occurred in the past time, one or more machine learning algorithms can be ran using the historical data in order create models that have increased accuracy of event detection.

In an operation 302, a set of model values based on the historical data is determined. For example, the set of model values are generated based on the historical data in order to generate a plurality of values and variables that can be used to generate one or more models. The set of model values include multiple variables with corresponding values. In some embodiments, the variables included are capable of enhancing the accuracy of models in predicting a particular event is present. In some embodiments, the variables may be determined by a user and programmed into the event detection system, the event detection system may then calculate values corresponding to each of the variables using the historical data (e.g., time-stamped values). In an exemplary embodiment, the variables may include appropriate transformations of current and historical sensor readings. In certain exemplary embodiments, variables may be used based on the particular event that is being detected. For example, in some embodiments, the one or more sensors may include flood detection sensors and similar variables may be used as described above with respect to the temperature sensors as variables for the flood detection sensors. In certain exemplary embodiments, historical data may be used from varying time periods.

In an operation 303, one or more models are generated based on the set of model values. For example, the set of model values are used in order to generate a first model. In some embodiments, the set of model values are further used to generate a second model, third model, fourth model, or twelve different models. In some embodiments, the set of model values are used with a machine learning algorithm in order to generate the first model. In some embodiments, other algorithms may be used in order to generate the first model. As discussed above, since the set of model values are based on the historical data, it is known whether an event happened at particular times, thus a machine learning algorithm can generate or output a model (e.g., a first model) that is supervised and tailored to accurately predict whether an event is present.

In exemplary embodiments, various machine learning methods that may be used. As described herein, a supervised model is one trained using known target outcome data while an unsupervised model does not have the benefit of known target data but may be adjusted to make useful estimations. Example machine learning methods may include, but are not limited to:
LOGISTIC REGRESSION ANALYSIS. A supervised, statistical modeling method for estimating binary outcomes (for example, is a fire event occurring or not);
PERCEPTRON (OR NEURON). A basic artificial neural network model that applies weights to relationships between input feature variables and the target variable;
MULTI-LAYER PERCEPTRON. An artificial neural network that uses multiple layers between the input feature variables and the target variable to establish relationships and weights between the input feature variables and the target variable. These models increase complexity over the neuron model, but can be more accurate in handling non-linear relationships between the feature variables and the target variable;
K-NEAREST NEIGHBORS (KNN). An algorithm that classifies occurrences to the same category (fire event or not) as the majority of its K closest training cases;
DECISION TREE. This method classifies cases according to the logic of a binary branching structure. The decision tree starts at the top and provides a split of the most discriminating (predictive) feature in the top node, and continues the branching logic down to the bottom nodes for the final classification of individual cases that are being classified;
RANDOM FOREST. This method provides the average classification based on many decision trees built on random subsets of the training data, to increase classification accuracy and limit overfitting problems;
ADABOOST (OR ADAPTIVE BOOSTING). In this method, an algorithm uses a weighted majority vote of a progressive sequence of decision tree classifiers. At each subsequent “boosting” iteration, training cases that were correctly classified are given a decreased weight and those that were incorrectly classified are given an increased weight, to force the algorithm to focus more on difficult training cases, to fine-tune the classifications;
GRADIENT BOOSTING. This method employs a boosting algorithm that sequentially chooses decision trees that minimize a loss function;
XGBOOST (OR EXTREME GRADIENT BOOSTING). This is a variation of gradient-boosted decision trees that was designed for more speed and efficiency;
SUPPORT VECTOR MACHINE (SVM). This method calculates one or more linear separators that provide the most separation of the fire events and non-events;
NAÏVE BAYES. This refers to a relatively simple and fast algorithm based on Bayes' theorem that often classifies well despite a sometimes faulty assumption that the features are independent of one other;
MAD3 ALGORITHM. An unsupervised threshold classification algorithm; and
ENSEMBLE. This method utilized provides a simple majority vote of select machine learning models that can overlook or cancel out errors of specific modeling methods and decrease error.

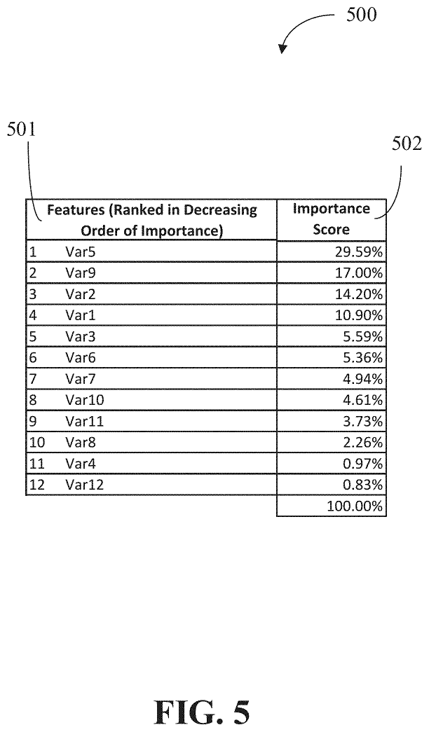

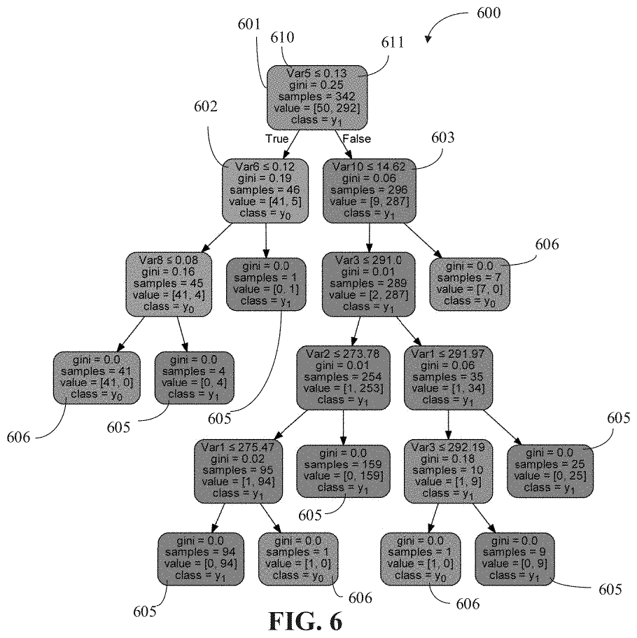

For example, the first model may correspond to a random forest model algorithm. That is, in such an example, the set of model values are input into a random forest model algorithm in order to generate the first model. Random forest models are discussed in further detail below with respect to FIGS. 5 and 6. For example, the random forest model may provide the average classification of whether the event is present based on multiple (e.g., 100, 1000, or more) decision trees (e.g., discussed in reference to FIG. 6) built on random subsets of the set of values (e.g., training values).

In some embodiments, the machine learning algorithms may include a logistic regression analysis, a perceptron neural network model, a multi-layer perceptron neural network model, a k-nearest neighbors algorithm, a decision tree model, a random forest mode, an adaptive boosting algorithm, a gradient boosting algorithm, an extreme gradient boosting algorithm, a support vector machine algorithm, a Naïve Bayes algorithm, or others.

For example, a logistic regression analysis may utilize statistical modeling algorithms with the set of model values in order to predict binary outcomes (e.g., yes or no). A perceptron neural network model includes an artificial neural network that calculates weights for each of the variables in the set of model values, where the weights are indicative of the relationship of the respective variable in predicting the target variable (e.g., the event). The k-nearest neighbors algorithm may classify cases to one or more categories (e.g., event present or not) as the majority of the closest training cases (e.g., cases in the historical data of the presence or non-presence of the event). The decision tree model may classify cases (e.g., event present or not) according to a logic of a binary branching structure. An example of the decision tree is discussed below in reference to FIG. 6. The adaptive boosting algorithm may use a weighted majority vote of a sequence of decision tree classifiers. The gradient boosting algorithm or extreme gradient boosting algorithm may sequentially choose decision trees that minimize a loss function. The support vector machine algorithm (SVM) may calculate one or more linear separators that provide the most separation between the events and non-events in the training data. The Naïve Bayes algorithm is based on Bayes' theorem and assumes that the variables are independent of one another.

In some embodiments, multiple models may be generated in operation 303 with each model corresponding to a different machine learning algorithm. Current data from one or more of the sensors may then be applied to each model, which outputs a prediction or determination of whether the event is present based on each model's unique comparison of the current conditions to the historical data.

In some embodiments, other algorithms may be used to generate a particular model. In some embodiments, one of the other algorithms may include a MAD3 algorithm as described in U.S. Pat. No. 9,679,255, the entirety of which is incorporated by reference. For example, such algorithm may include determining an upper set point and a lower set point for one or more of the variables. In some embodiments, the upper set point may be determined by adding an offset value to one of the variables and the lower set point may be determined by subtracting the offset value to one of the variables. In some embodiments, the offset value may be determined by determining a plurality of combined averages for each of the one or more of the sensors. The plurality of combined averages may be determined by averaging, at different times, the current value, with a mid-term average (e.g., 30-minute value), and a long-term average (e.g., one-month average value). The plurality of combined averages for the one or more of the sensors may then be fit to a model distribution in order to determine a standard deviation. The offset value may then be the standard deviation multiplied by a goodness-of-fit value, where the goodness-of-fit value is determined based on the fit of the plurality of combined averages and the model distribution. In other embodiments, the offset value may be the standard deviation of the plurality of combined averages. For example, the offset value may be added to a most-recent combined average of a sensor in order to determine the upper set point and subtracted from the most-recent combined average of the sensor in order to determine the lower set point. The most-recent combined average may be an average of the most-recent current (e.g., real-time) value, most-recent mid-term moving average, and most-recent long-term moving average. In some embodiments, the model may determine that the event is present if the current data (e.g., current value of the sensor) exceeds the upper set point. Similarly, the event detection system may also determine that the event is present or that there is a possible problem if the current data (e.g., current value of the sensor) is below the lower set point.

In an example embodiment, a first model may be generated from (e.g., or based on) the random forest model algorithm, a second model may be generated from (e.g., or based on) k-nearest neighbors algorithm, a third model may be generated (e.g., or based on) from the MAD3 algorithm, a fourth model may be generated from the perceptron neural network model, and a fifth model may be generated from a Naïve Bayes algorithm. In other embodiments, different models, fewer models, or a greater number of models may be ensembled. In exemplary embodiments, the models in an ensemble may be chosen to: Maximize overall classification performance by including only the models with the highest average classification performance; Offset the weaknesses of specific models in certain events by including other models that perform better in those events; Make classifications and estimates robust by including models that are based on fundamentally different algorithms; and Provide continuity with historical estimates by including older models. In such exemplary embodiments, the goal of using an ensemble for classifications is to improve and stabilize overall classification performance. In exemplary embodiments, models can be added or removed over time to maintain or improve classification performance.

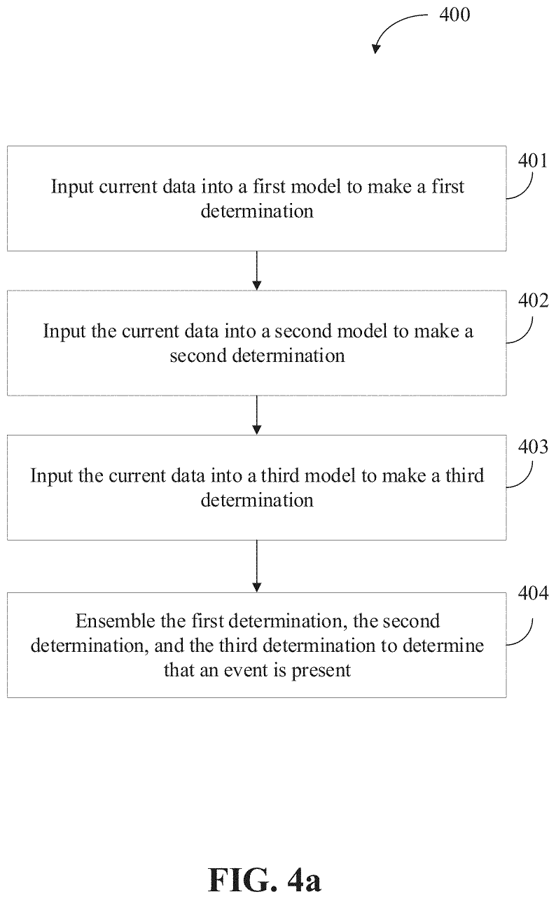

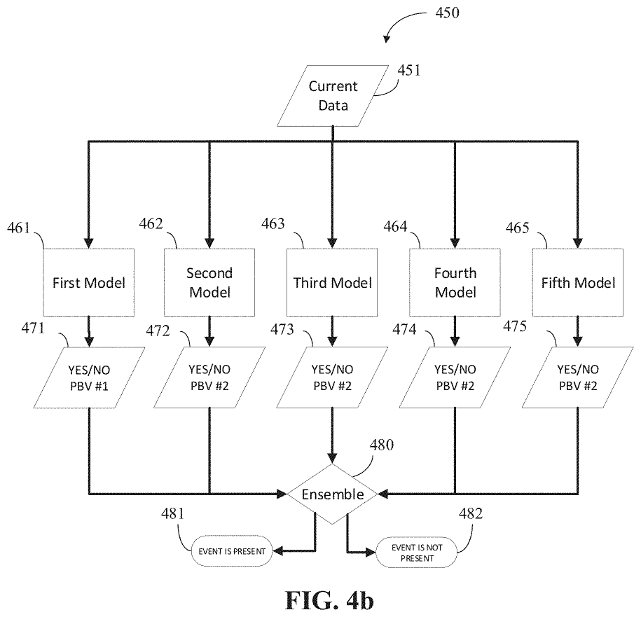

Moreover, since each of the models may not be perfect (e.g., due to flaws in the machine learning algorithms or lack of enough historical data) and sometimes output false positives or false negatives, all of the models may be ensembled by the event detection system in order to make a more accurate final determination of whether the event is present. For example, if a majority of the models indicate that the event is present, then the event detection system may determine that the event is present. However, if a majority of the models indicate that the event is not present, then the event detection system may determine that the event is not present. In some embodiments, the event detection system may determine that the event is present if a threshold number (e.g., 4 out of 13) of the models indicate that the event is present. In some embodiments, the threshold number may be determined, set, or updated via a user input into the event detection system. In some embodiments, each of the models may output a probability value. Each of the models may be updated or re-generated continuously or at discrete periods of time (e.g., once a day, once a week, once a month, etc.) Additional discussion of the use of the models with current data and an ensemble approach by the event detection system is discussed in further detail with respect to FIG. 4.

FIGS. 4a and 4b are referred to in tandem herein to aid in the illustration of the event detection system. FIG. 4a is a flow diagram of a method of determining an occurrence of an event in accordance with an illustrative embodiment. FIG. 4b is a block diagram depicting the flow of data in determining the presence of the event in accordance with an illustrative embodiment. In an operation 401, current data 451 is input into a first model 461 to make a first determination (e.g., depicted by output data block 471). That is, the current data 451 is received or accessed by the event detection system from the one or more sensors. The current data may include real-time values from the one or more sensors and/or arithmetic means of the most recent values (e.g., values from the past minutes, hours, weeks, or months) from each of the one or more sensors. In some embodiments, the arithmetic means may be calculated by the event detection system based most-recent real-time values or pre-calculated and received values. The current data is then input into or used with the generated first model and the first determination is made. In some embodiments, the first determination is binary (e.g., yes, the event is present or no, the event is not preset). In some embodiments, the first determination includes a binary determination and also a probability value (e.g., PBV #4) indicative of how probable it is that the event is occurring or likely to occur. In some embodiments, the first determination includes the probability value. In some embodiments, the probability value may be compared to a first threshold value that may be used to determine, based on the probability value, whether the event is present or an emergency condition is present. In some embodiments, the first threshold value may be determined, set, or updated by a user input to the event detection system.

In an operation 402, the current data 451 is input into a second model 462 to make a second determination (e.g., depicted by output data block 472). Similarly, the current data is then input into or used with the generated second model and the second determination is made. In some embodiments, the second determination is binary (e.g., yes, the event is present or no, the event is not preset). In some embodiments, the second determination includes a binary determination and also a second probability value (e.g., PBV #2) indicative of how probable it is that the event is occurring or likely to occur. In some embodiments, the second determination includes just the second probability value. In some embodiments, the second probability value may be compared to a second threshold value that may be used to determine, based on the second probability value, whether the event is present or an emergency condition is present. In some embodiments, the second threshold value may be determined, set, or updated by a user input to the event detection system.

In an operation 403, the current data 451 is input into a third model 463 to make a third determination (e.g., depicted by output data block 473). Again similar to the other models, the current data 451 is then input into or used with the generated third model 463 and the third determination is made. In some embodiments, the third determination is binary (e.g., yes, the event is present or no, the event is not present). In some embodiments, the third determination includes a binary determination and also a third probability value (e.g., PBV #3) indicative of how probable it is that the event is occurring or likely to occur. In some embodiments, the third determination includes just the third probability value. In some embodiments, the third probability value may be compared to a third threshold value that may be used to determine, based on the third probability value, whether the event is present or an emergency condition is present. In some embodiments, the third threshold value may be determined, set, or updated by a user input to the event detection system. Moreover, in some embodiments, the method 400 may also include, similar to as described above, inputting the current data into a fourth model 464 to make a fourth determination (e.g., depicted by output data block 474), inputting the current data 451 into a fifth model 465 to make a fifth determination (e.g., depicted by output data block 475). In some embodiments, twelve, thirteen, or more models may be utilized, each receiving the current data 451 as an input and generating a respective determination (e.g., depicted output data block).

In an operation 404, the first, second, and third determinations are ensembled (e.g., at decision block 480) to determine whether an event is present or has occurred. That is, the event detection system determines whether the event is present by analyzing all of the determinations made from each model. In one embodiment, a majority vote count of the first, second, third, etc., determinations is used to determine whether the event is present. For example, if a majority of the models (e.g., 3 out of the 5 determinations) are positive (e.g., yes, indicative of the presence of the event), then the event detection system may determine that the event (e.g., possible emergency condition) is present (e.g., depicted as output block 481). It is to be appreciated that FIGS. 4a and 4b are meant by way of example and that in other embodiments additional models may be generated, used, and ensembled to determine whether the event is present.

The event detection system may compile the probability values (e.g., PBV #1-5) in order to determine whether the event is present. In some embodiments, the event detection system may output the probability values or an ensembled probability value (e.g., an average or weighted average of all of the probability values) to user interface on a display to a user. In such embodiments, the user may then intervene in time to prevent the event from happening or take precautionary steps (e.g., such as ordering an evacuation of the building or area). In some embodiments, the weights may be assigned to the probability values based on the accuracy of the particular model (e.g., determined based on the historical data). In some embodiments, the weights may be determined, set, or updated by an input from a user to the event detection system. The probability values and/or ensembled probability value (e.g., weighted probability value) may indicate that an event is likely to occur or close to occurring. In some embodiments, the ensembled probability value may be compared to an event threshold value in order to determine that the event is present (e.g., and thereby cause the notification to be triggered or transmitted in operation 205). In some embodiments, the event may include a possible emergency condition such as a flood, fire, gas leak, etc.

The ensemble approach increases the accuracy of the event detection because it utilizes multiple models that alone may possess errors or be unable to accurately detect the presence of an event. However, the use of multiple models increases the accuracy of the event detection, thereby reducing the false negative alarms and ensuring that positive event conditions are detected, which greatly increases the efficacy of the event detection system. Further, the event detection system may continually update the models over time to increase the accuracy. In addition, the methods described herein (e.g., utilizing an ensemble approach) allows for the system to overcome situational weaknesses of specific modeling methods in order to ensure events and non-events are accurately determined.

FIG. 5 depicts a table 500 including multiple variables and determined importance in event detection in accordance with an illustrative embodiment. In particular, the table 500 depicts a relative importance of various sensor data variables for an example of a machine learning algorithm (e.g., a random forest model). The table 500 includes examples of variables (e.g., features) used in the set of model values 501 measured or monitored by one or more sensors and corresponding importance scores 502. The table 500 ranks and quantifies variable importance for a random forest model that samples and re-samples the historical data to build multiple (e.g., 1000) decision trees. For example, in the process of building a first model, the event detection system 100 may sample and re-sample the historical data to determine which variables 501 are the most important (e.g., indicated by the importance scores 502) for determining that a particular event (e.g., a fire) is present. In this example, the values corresponding to the variables Var5 and Var9 are determined using the random forest model as the best indicators of whether a fire (e.g., event or possible emergency condition) is present.

FIG. 6 depicts an example of a decision tree 600 of a random forest model in accordance with an illustrative embodiment. The decision tree 600 is a decision tree of a random forest model (e.g., a first model) generated from historical data. For example, a random forest model may have multiple decision trees such as the decision tree 600. Each of the decision trees may be used to determine the presence of a particular event that the decision trees were built for and then the outputs of each decision tree (e.g., decision tree 600) may be combined to make a determination whether the particular event is present.

The decision tree 600 includes multiple decision nodes. For example, a first decision node 601 may be at the top or beginning of the tree. The first decision node 601 receives a value 610 from the set of model values of a particular variable (e.g., feature) and the value 610 is compared to a threshold 611 that was determined when the model was generated (e.g., via running the machine learning algorithm). If the comparison is true, then the decision tree 600 proceeds to a second node 602 for a comparison between a second value from the set of model values of a second particular variable (e.g., feature) and the second value is compared to a second threshold that was determined when the model was generated. If the comparison is false, then the decision tree 600 proceeds to a third node 603 for a comparison between a third value from the set of model values of a third particular variable (e.g., feature) and the third value is compared to a third threshold that was determined when the model was generated. The decision tree 600 proceeds with these comparisons between various values from the set of model values and thresholds determined when the model was generated until a decision node is reached. For example, decision nodes 605 may indicate that the event is present and the decision nodes 606 may indicate that the event is not present.

In some embodiments, the decision node 606 that is reached after the sequential comparisons represents the determination of the particular decision tree. The other decision trees within the random forest model (e.g., first model) will similarly output a determination. All of the determinations may be compiled by the event detection system in order to make a first determination based on the first model (e.g., the random forest model). In some embodiments, the first determination is determined to be positive (e.g., yes the event is present) if a majority of the decision trees have determined the event to be present. In some embodiments, all of the decision trees of the random forest model (e.g., the first model) may output a probability value or other value that may be used by the event detection system in order to make the first determination based on the first model whether the event is present. It is to be appreciated that FIG. 6 is meant by way of example of a portion of one particular model generated by a machine learning algorithm (e.g., random forest model) and that other models and machine learning algorithms may be used in various implementations.

Having now described some illustrative implementations, it is apparent that the foregoing is illustrative and not limiting, having been presented by way of example. In particular, although many of the examples presented herein involve specific combinations of method acts or system elements, those acts and those elements can be combined in other ways to accomplish the same objectives. Acts, elements and features discussed in connection with one implementation are not intended to be excluded from a similar role in other implementations.

The hardware and data processing components used to implement the various processes, operations, illustrative logics, logical blocks, modules and circuits described in connection with the embodiments disclosed herein may be implemented or performed with a general purpose single- or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device, etc.) may include one or more devices (e.g., RAM, ROM, Flash memory, hard disk storage, etc.) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit and/or the processor) the one or more processes described herein.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular can also embrace implementations including a plurality of these elements, and any references in plural to any implementation or element or act herein can also embrace implementations including only a single element. References in the singular or plural form are not intended to limit the presently disclosed systems or methods, their components, acts, or elements to single or plural configurations. References to any act or element being based on any information, act or element can include implementations where the act or element is based at least in part on any information, act, or element.

Any implementation disclosed herein can be combined with any other implementation or embodiment, and references to “an implementation,” “some implementations,” “one implementation” or the like are not necessarily mutually exclusive and are intended to indicate that a particular feature, structure, or characteristic described in connection with the implementation can be included in at least one implementation or embodiment. Such terms as used herein are not necessarily all referring to the same implementation. Any implementation can be combined with any other implementation, inclusively or exclusively, in any manner consistent with the aspects and implementations disclosed herein.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

Systems and methods described herein may be embodied in other specific forms without departing from the characteristics thereof. Further relative parallel, perpendicular, vertical or other positioning or orientation descriptions include variations within +/−10% or +/−10 degrees of pure vertical, parallel or perpendicular positioning. References to “approximately,” “about” “substantially” or other terms of degree include variations of +/−10% from the given measurement, unit, or range unless explicitly indicated otherwise. Coupled elements can be electrically, mechanically, or physically coupled with one another directly or with intervening elements. Scope of the systems and methods described herein is thus indicated by the appended claims, rather than the foregoing description, and changes that come within the meaning and range of equivalency of the claims are embraced therein.

The term “coupled” and variations thereof includes the joining of two members directly or indirectly to one another. Such joining may be stationary (e.g., permanent or fixed) or moveable (e.g., removable or releasable). Such joining may be achieved with the two members coupled directly with or to each other, with the two members coupled with each other using a separate intervening member and any additional intermediate members coupled with one another, or with the two members coupled with each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References to “or” can be construed as inclusive so that any terms described using “or” can indicate any of a single, more than one, and all of the described terms. A reference to “at least one of ‘A’ and ‘B’” can include only ‘A’, only ‘B’, as well as both ‘A’ and 13′. Such references used in conjunction with “comprising” or other open terminology can include additional items.

Modifications of described elements and acts such as variations in sizes, dimensions, structures, shapes and proportions of the various elements, values of parameters, mounting arrangements, use of materials, colors, orientations can occur without materially departing from the teachings and advantages of the subject matter disclosed herein. For example, elements shown as integrally formed can be constructed of multiple parts or elements, the position of elements can be reversed or otherwise varied, and the nature or number of discrete elements or positions can be altered or varied. Other substitutions, modifications, changes and omissions can also be made in the design, operating conditions and arrangement of the disclosed elements and operations without departing from the scope of the present disclosure.

References herein to the positions of elements (e.g., “top,” “bottom,” “above,” “below”) are merely used to describe the orientation of various elements in the FIGURES. The orientation of various elements may differ according to other exemplary embodiments, and that such variations are intended to be encompassed by the present disclosure.

What is claimed is:

1. A method of determining a presence of an event comprising:
accessing, by an event detection system, multiple models;
determining, by the event detection system, current data from one or more of the sensors, wherein the current data comprises a real-time value from one or more of the sensors;
utilizing, by the event detection system, each model and the current data to make respective determinations of whether an event is present;
determining, by the event detection system, that the event is present based on the respective determinations; and
transmitting, by the event detection system, a notification in response to determining the event.

2. The method of claim 1, wherein determining that the event is present comprises determining whether a majority out of the respective determinations indicate that the event is present.

3. The method of claim 1, wherein the multiple models comprise a first model, a second model and a third model, and wherein the respective determinations comprise a first determination, a second determination, and a third determination.

4. The method of claim 2, wherein the first determination comprises a first binary indication of whether the event is present, the second determination comprises a second binary indication of whether the event is present, and the third determination comprises a third binary indication of whether the event is present.

5. The method of claim 4, wherein determining that the event is present comprises determining that two out of the first, second, and third binary indications are positive.

6. The method of claim 1, wherein the current data further comprises an arithmetic mean of the values received from the one or more sensors over a first predetermined period of time, an arithmetic mean of the values received from the one or more sensors over a second predetermined period of time, and an arithmetic mean of the values received from the one or more sensors over a third predetermined period of time.

7. The method of claim 1, further comprising:
accessing, by the event detection system, historical data, the historical data comprising timestamped values detected by one or more sensors over a first time period;
determining, by the event detection system, a set of model values using the time stamped values; and
generating, by the event detection system, the first model from the set of model values, the second model from the set of model values, and the third model from the set of values.

8. A system comprising:
a sensor configured to sense data indicative of an event in a structure; and
a computing device in communication with the sensor, wherein the computing device comprises:
a transceiver configured to receive the data from the sensor over time;
a memory configured to store the data, wherein the data comprises a plurality of values that are each indicative of a sensed condition at a unique time, and
a processor operatively coupled to the memory and the transceiver, and configured to:
determine a set of model values using the data received from the sensor over a period of time;
generate a first model corresponding to a first machine learning model, a second model corresponding to a second machine learning algorithm, and a third model corresponding to a third algorithm;
determine that an event is present based on current data of the sensor, the first model, and the third model, wherein the recent data comprises a real-time value of the sensor; and
cause a notification to be transmitted in response to determining the event is present.

9. The system of claim 8, wherein the set of model values are each indicative of a sensed condition, and wherein the sensed condition is one of a temperature, an amount of smoke obscuration, or an amount of gas in the atmosphere.

10. The system of claim 8, wherein the set of model values comprise rolling averages calculated over a first, second, third, or forth time period for values received from the sensor at particular times within the time period.

11. The system of claim 8, wherein the first machine learning algorithm is a k-nearest neighbor algorithm, the second machine learning algorithm is a random forest algorithm, and the third algorithm is a MAD3 algorithm.

12. The system of claim 8, wherein to determine the event is present, the processor is further configured to:
input the current data into the first model to make a first determination whether the event is present;
input the current data into the second model to make a second determination whether event is present;
input the current data into the third model to make a third determination whether the event is present; and
determine that the event is present based one the first determination, the second determination, and the third determination.

13. The system of claim 12, wherein the third determination indicates that the event is present when the real-time value of the current data exceeds an upper set point.

14. The system of claim 12, wherein to determine that the event is present based on the first determination, the second determination, and the third determination, the processor is further configured to implement an ensemble, wherein the ensemble comprises a majority vote of the first determination, the second determination, and the third determination.

15. The system of claim 12, wherein the first determination comprises a first probability value, the second determination comprises a second probability value, and the third determination comprises a third probability value.

16. The system of claim 12, wherein to determine that the event is present based one the first determination, the second determination, and the third determination, the processor is further configured to determine an average of the first probability, the second probability, and the third probability and determine that the event is present if the average is greater than a pre-defined threshold.

17. A method of determining an event comprising:
accessing, by the event detection system, historical data, the historical data comprising timestamped values detected by one or more sensors over a first time period;
determining, by the event detection system, a set of model values using the time stamped values;
generating, by the event detection system, a first model from the set of values and a second model from the set of model values;
determining, by the remote computing device, current data from one or more of the sensors, wherein the current data comprises a real-time value from one or more of the sensors;
determining, by the remote computing device, that an event is present based on the current data, the first model, and the second model; and
causing, by the remote computing device, a notification to be transmitted in response to determining the event is present.

18. The method of claim 17, wherein values corresponding to historical data are indicative of a sensed condition, and wherein the sensed condition is one of a temperature, an amount of smoke obscuration, or an amount of gas in the atmosphere.

19. The method of claim 17, wherein to determine that the event is present, the processor is further configured to determine a first probability that the event is present from the first model and determine a second probability that the event is present from the second model.

20. The method of claim 19, wherein the event is determined to be present if the first probability exceeds a first pre-defined threshold and the second probability exceeds a second pre-defined threshold.
